(19) United States
(12) Patent Application Publication
(10) Pub. No.: US 2016/0265926 A1
(43) Pub. Date: Sep. 15, 2016

(54) POSITION STATE ESTIMATION DEVICE AND POSITION STATE ESTIMATION METHOD

(71) Applicant: KABUSHIKI KAISHA TOSHIBA, Minato-ku (JP)

(72) Inventor: Makoto SATO, Shinagawa (JP)

(73) Assignee: KABUSHIKI KAISHA TOSHIBA, Minato-ku (JP)

(21) Appl. No.: 15/057,460

(22) Filed: Mar. 1, 2016

(30) Foreign Application Priority Data
Mar. 10, 2015 (JP) 2015-046931

(51) Int. Cl. G01C 21/34

(52) U.S. Cl. CPC G01C 21/34; G01C 21/3423

(57) ABSTRACT

A position state estimation device according to an embodiment estimates a position state including a position of a moving object. The device includes an evaluator, an estimator, a selector, a searcher, and a sampler. Based on a measurement value of the position state at time (t), the evaluator calculates an evaluation value of a sample (t) of the position state at the time (t). Based on the sample (t) and the evaluation value, the estimator estimates the position state at the time (t). Based on the estimated position state at the time (t), the selector selects a destination of the moving object from among destination candidates. The searcher searches for a valid path to the destination. Based on a transition model of the position state, the sample (t), and the valid path, the sampler generates a plurality of samples (t+1) for a subsequent operation timing after the time (t).

### CROSS REFERENCE TO RELATED APPLICATION(S)

This application is based upon and claims the benefit of priority from the prior Japanese Patent Application No. 2015-046931, filed on Mar. 10, 2015, the entire contents of which are incorporated herein by reference.

### FIELD

Embodiments described herein relate generally to a position state estimation device and a position state estimation method.

### BACKGROUND

In recent years, much attention has been focused on position state estimation in which a position and a state of a moving object are estimated in detail based on a history of position state data for the moving object; for example, “the moving object is moving on this road at a speed of XX by car”. An estimation result for a position state can be used to provide real-time information in such cases as “showing information upon getting off the car”.

In the past, methods for estimating the position state have been proposed, such as a rule-based method in which a predetermined position state is estimated when the position state data satisfies a specific condition, and a method using a particle filter that estimates the position state using a transition model of the position state. The particle filter generates a plurality of samples of the position state (position estimation particles) through a simulation using the transition model and estimates the position state based on the samples and the position state data.

In order to estimate the position state of a person using the particle filter, it is considered to obtain the position state data from a portable terminal such as a smartphone. However, movement activities of a person are so various that, with a low frequency in sampling of the position state data, there is a risk of an explosive increase in position state candidates until the subsequent position state data is obtained.

Therefore, an accurate estimation of the position state has required generation of a great number of samples. In this case, a larger number of samples has needed a longer period of time for calculation, making it difficult to use this method to provide real-time information.

### BRIEF DESCRIPTION OF THE DRAWINGS

FIG. 1 is a diagram illustrating a configuration of a portable terminal;

FIG. 2 is a diagram illustrating exemplary position state data;

FIG. 3 is a diagram illustrating a configuration of a position state estimation device;

FIG. 4 is a diagram illustrating exemplary samples;

FIG. 5 is a diagram illustrating an exemplary transition model;

FIG. 6 is a diagram illustrating an exemplary evaluation model;

FIG. 7 is a diagram illustrating exemplary evaluation values;

FIG. 8 is a diagram illustrating exemplary estimation results for position states;

FIG. 9 is a schematic diagram illustrating exemplary path information;

FIG. 10 is a schematic diagram illustrating an exemplary valid path;

FIG. 11 is a flowchart illustrating operation of the position state estimation device;

FIG. 12 is a diagram illustrating exemplary initial samples;

FIG. 13 is a diagram illustrating exemplary samples generated by a conventional estimation device; and

FIG. 14 is a diagram illustrating exemplary samples generated by the estimation device according to an embodiment.

### DETAILED DESCRIPTION

Embodiments will now be explained with reference to the accompanying drawings. The present invention is not limited to the embodiments.

A position state estimation device according to an embodiment estimates a position state including a position of a moving object. The position state estimation device includes an evaluator, an estimator, a selector, a searcher, and a sampler. Based on a measurement value of the position state at time (t), the evaluator calculates an evaluation value of a sample (t) of the position state at the time (t). Based on the sample (t) and the evaluation value, the estimator estimates the position state at the time (t). Based on the estimated position state at the time (t), the selector selects a destination of the moving object from among destination candidates. The searcher searches for a valid path to the destination. Based on a transition model of the position state, the sample (t), and the valid path, the sampler generates a plurality of samples (t+1) for a subsequent operation timing after the time (t).

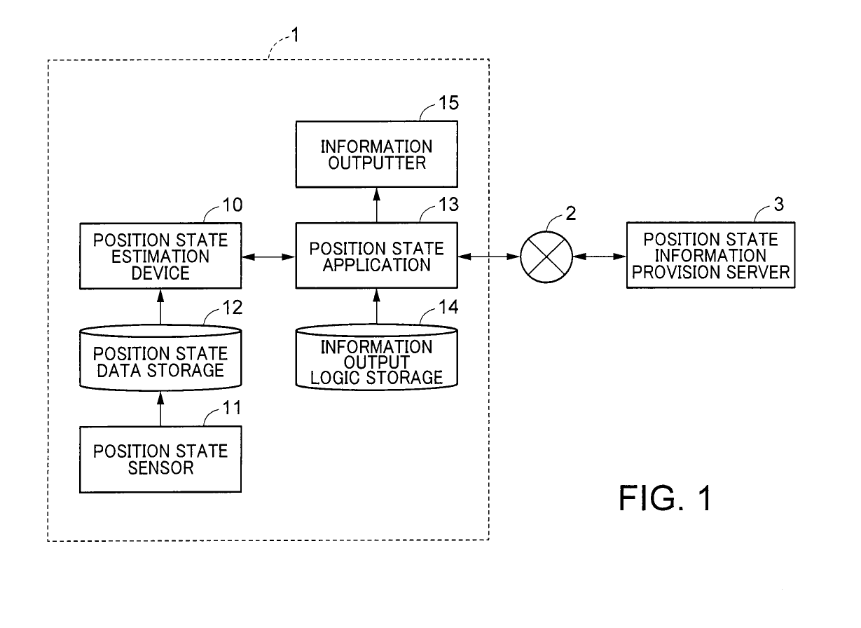

The position state estimation device according to the embodiment (hereinafter, referred to as “estimation device”) will be described with reference to FIGS. 1 to 10. The estimation device according to the embodiment uses a particle filter to estimate the position state of the moving object. The position state is information on behavior of the moving object in a space, including a position and a state of the moving object. The state of the moving object includes a speed, a movement direction, a movement means, and the like. Hereinafter, the moving object is assumed as a person. In addition, a person of which the position state is to be estimated is referred to as user.

FIG. 1 is a diagram illustrating a configuration of a portable terminal 1 including an estimation device 10 according to the embodiment. As illustrated in FIG. 1, the portable terminal 1 includes the estimation device 10, a position state sensor 11, a position state data storage 12, a position state application 13, an information output logic storage 14, and an information outputter 15.

The position state sensor 11 measures the position state of the user at a predetermined time interval to output the measured position state data. The position state sensor 11 includes a position sensor using a GPS or Wi-Fi to measure a position of the portable terminal 1, and an acceleration sensor that measures acceleration of the portable terminal 1. Additionally, the position state data may include a position state obtained by processing a measurement value from the position state sensor 11.

The position state data storage 12 stores the position state data output by the position state sensor 11. The estimation device 10 uses the position state data stored in the position state data storage 12 to estimate the position state of the user of the portable terminal 1.

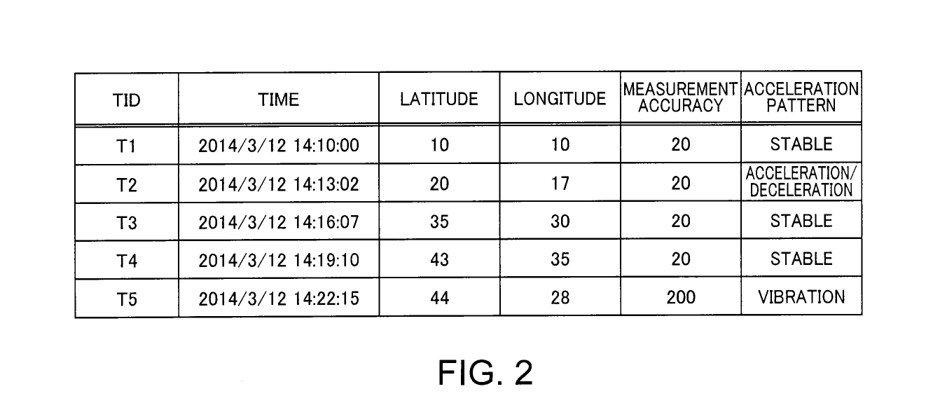

FIG. 2 is a diagram illustrating exemplary position state data stored in the position state data storage 12. Each item of the position state data in FIG. 2 includes measuring time of day, longitude, latitude, measurement accuracy, and an acceleration pattern. For example, in the position state data at time T1, the measuring time of day is 14:10:00, Mar. 12, 2014; the longitude is 10 degrees; the latitude is 10 degrees; the measurement accuracy (measurement error) is 20 m; and the acceleration pattern is “stable”. The longitude, the latitude, and the measurement accuracy can be obtained from the position sensor. Meanwhile, the acceleration pattern can be obtained by processing a measurement value from the acceleration sensor. The position state data may include a movement direction and the like.

The position state application 13 is software installed in the portable terminal 1, and is loaded on a memory and executed by a CPU. The position state application 13 obtains the position state estimated by the estimation device 10 and outputs information in accordance with the position state of the user to provide a service for the user.

The information output logic storage 14 stores an information output logic for the position state application 13. The information output logic includes a condition section in which a condition for the position state is described, and an operation section in which operation of the position state application 13 when the condition is satisfied is described.

The position state application 13 obtains an estimation result from the estimation device 10 and, in a case where the obtained position state satisfies the condition described in the condition section, executes the operation described in the operation section. When the position state satisfies a predetermined condition, for example, the position state application 13 sends a query to a position state information provision server 3 via a public line 2 and outputs information obtained from the position state information provision server 3.

The information outputter 15 is a display device or an audio output device in the portable terminal 1, for example. The information output by the position state application 13 (map information or the like) is output through the information outputter 15.

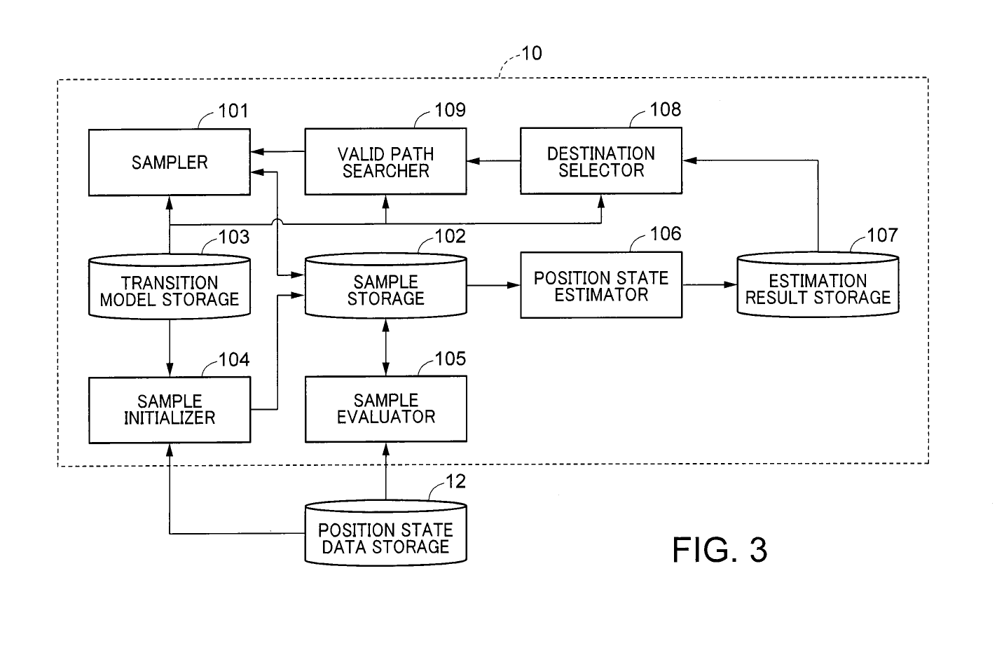

FIG. 3 is a diagram illustrating a configuration of the estimation device 10. The estimation device 10 according to the embodiment carries out an estimation process for the position state at a predetermined time interval set with a timer, or at a timing when new position state data is stored in the position state data storage 12. Hereinafter, the current operation timing is referred to as time (t) and the subsequent operation timing is referred to as time (t+1). Additionally, it is assumed that the estimation device 10 obtains position state data (t) for the time (t) from the position state data storage 12 at the time (t).

As illustrated in FIG. 3, the estimation device 10 includes a sampler 101, a sample storage 102, a transition model storage 103, a sample initializer 104, a sample evaluator 105, a position state estimator 106, an estimation result storage 107, a destination selector 108, and a valid path searcher 109.

The sampler 101 generates a plurality of samples of the position state of the user. The sample of the position state is a position state candidate at certain time and corresponds to a particle in the particle filter. Based on a transition model described later, a sample (t) at the time (t) generated in advance, and a valid path described later, the sampler 101 generates a sample (t+1) at the time (t+1). Specifically, some samples (t) are selected from among the samples (t) stored in the sample storage 102 and transition of the selected samples (t) is carried out based on the transition model so that the samples (t+1) are generated. At this time, the sampler 101 generates the samples (t+1) located on the valid paths. In other words, by assuming that the user moves efficiently, paths with a lower possibility of moving thereto are pruned to generate the samples located on the valid paths with a higher possibility of moving thereto. A method for generating the samples will be described later in detail.

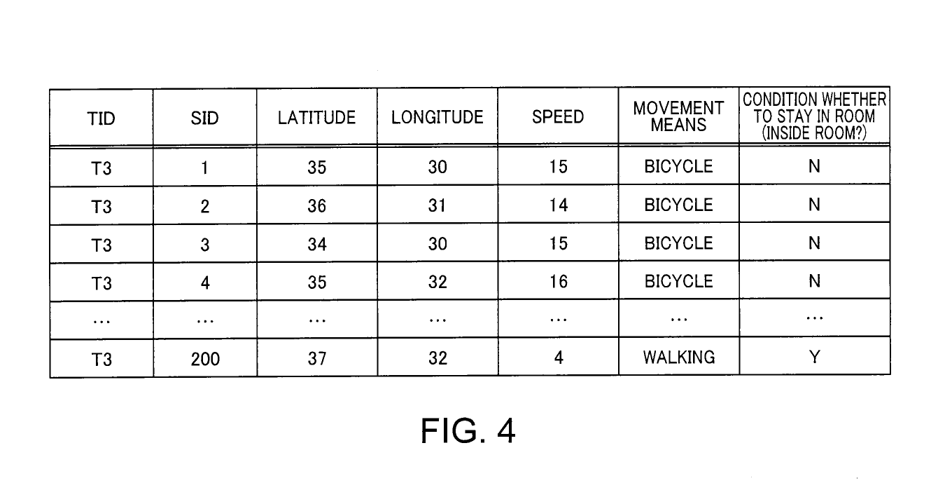

The sample storage 102 stores the plurality of samples generated by the sampler 101. FIG. 4 is a diagram illustrating exemplary samples stored by the sample storage 102. The samples in FIG. 4 are samples at time T3 and the position state includes a position of the user (the latitude and the longitude) and a state of the user (the speed, the movement means, and a condition whether to stay in the room). For example, in the position state of a sample 1 (SID=1), the latitude is 35 degrees; the longitude is 30 degrees; the speed is 15 km/h; the movement means is a bicycle; and the condition whether to stay in the room is outside the room (inside the room=N).

In the example in FIG. 4, the sampler 101 generates 200 samples. However, the number of samples to be generated by the sampler 101 can be set arbitrarily. In addition, the position of the user may include an altitude, a height above sea level, the number of floors, and the like. Furthermore, the state of the user may include the acceleration, the movement direction, and the like.

The transition model storage 103 stores the transition model and path information. The transition model is a model indicating how the transition of the position state at the time (t) is carried out for the time (t+1). The transition model is expressed as a transition probability of each state, for example. The path information is information on a path in which the user moves. The path information will be described later. The sampler 101 carries out transition of the samples (t) stored in the sample storage 102 based on the transition model so that the samples (t+1) are generated.

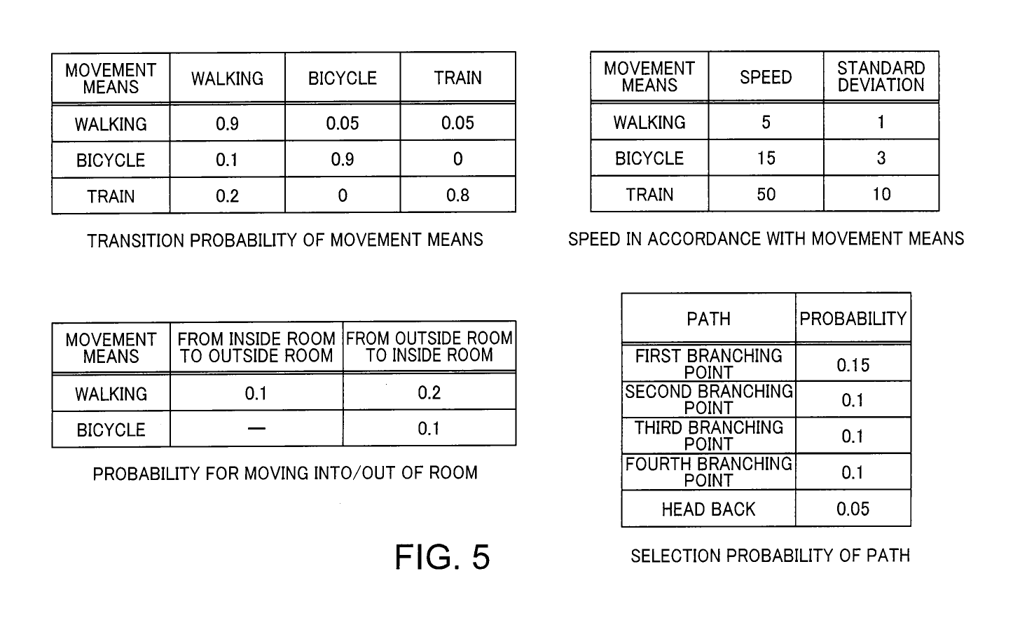

FIG. 5 is a diagram illustrating an exemplary transition model. The transition model in FIG. 5 includes the transition probability of the movement means, the speed in accordance with the movement means, a probability for moving into/out of the room in accordance with the movement means, and a selection probability of the path. For example, in the example in FIG. 5, when the movement means at the time (t) is walking, a probability for a case where the movement means at the time (t+1) is walking is 90%, a probability for a bicycle is 5%, and a probability for a train is 5%. An average speed of the user for a case where the movement means is walking is 5 km/h and a standard deviation thereof in speed is 1 km/h. When the movement means at the time (t) is walking, a probability for moving from inside the room to outside the room at the time (t+1) is 10% (a probability for remaining inside the room is 90%), a probability for moving from outside the room to inside the room is 20% (a probability for remaining outside the room is 80%). When the user passes through a branching point, a probability for passing through a first branching point is 15%; a probability for passing through a second branching point is 10%; a probability for passing through a third branching point is 10%; a probability for passing through a fourth branching point is 10%; and a probability for heading back on a path (backtracking on a path that the user originally has come along) is 5%. The selection probability of the path is used in combination with the path information described later.

The sample initializer 104 (hereinafter, referred to as “initializer 104”) generates a plurality of initial samples. The initial sample is a sample generated not based on a sample generated in advance. When no sample is stored in the sample storage 102, for example, in a case when the estimation device 10 starts to operate, the sampler 101 cannot generate the sample (t+1) based on the sample (t). In this case, the initializer 104 generates the initial sample.

Specifically, based on the position state data (t) at the time (t) obtained from the position state data storage 12, the initializer 104 generates a plurality of initial samples (t). The initial sample (t) may be generated from the position state data (t) at random, or alternatively, may be generated using the transition model. The initial sample (t) is stored in the sample storage 102. The sampler 101 can generate the sample (t+1) based on the initial sample (t) stored in the sample storage 102.

Based on the position state data (t) obtained from the position state data storage 12, the sample evaluator 105 (hereinafter, referred to as “evaluator 105”) individually calculates the evaluation values of the respective samples (t) stored in the sample storage 102. The evaluation value is calculated based on likelihood of the sample (t) with respect to the position state data (t). The likelihood of the sample (t) is a probability of the position state data (t) being obtained in a case where the position state of the sample (t) is correct. A higher evaluation value is calculated for higher likelihood. As a calculation method for the evaluation value, a penalty method, using Gaussian distribution available in an area of a Kalman filter or the particle filter, can be employed. For example, the evaluation value is calculated using the following expression.

$$\begin{matrix}[ Math . 1 ] & \\ L ( y \vert x , {y}^{′} ) \sim exp ( - \frac{1}{2} \{ \frac{{( ϕ ( x ) - {ϕ}^{′} ( y , {y}^{′} ) )}^{2}}{σ {1}^{2}} + \frac{{( x - y )}^{2}}{σ {2}^{2}} \} ) & ( 1 )\end{matrix}$$

In expression (1), x indicates a position of the user contained in the sample (t); y indicates a position of the user contained in the position state data (t); y′ indicates a position of the user contained in position state data (t−1) at time (t−1) serving as a previous operation timing; φ(x) indicates a movement direction of the user estimated from x; φ′(y,y′) indicates a movement direction of the user estimated from y and y′; and σ1 and σ2 indicate parameters relating to reliability for measurement of the position state data.

As it is clear from expression (1), the evaluation value becomes smaller as a difference between the position x of the user contained in the sample (t) and the position y of the user contained in the position state data (t) is enlarged. The evaluation value also becomes smaller as a difference between the movement direction of the user estimated from the sample (t) and the movement direction estimated from the position state data (t) is enlarged. This is because the likelihood of the sample (t) becomes lower as a difference between the sample (t) and the position state data (t) is enlarged.

In addition, the evaluation value becomes larger as the reliability for measurement of the position state data is made higher. The parameters σ1 and σ2 may be calculated, for example, based on measurement accuracy contained in the position state data. As illustrated in FIG. 2, in the case of the measurement accuracy being expressed as the measurement error, lower measurement accuracy has higher reliability. The parameters σ1 and σ2 may also be calculated using an evaluation model set in advance.

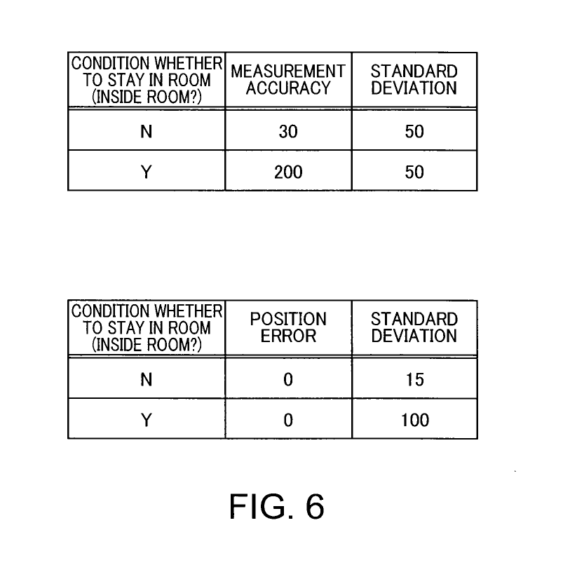

FIG. 6 is a diagram illustrating an exemplary evaluation model. The evaluation model illustrated in FIG. 6 includes the measurement accuracy of the position state data inside/outside the room and a position error. For example, in the example in FIG. 6, the measurement error outside the room (inside the room=N) is 30 m and the standard deviation thereof is 50 m. The evaluator 105 may store such evaluation model in advance to calculate the evaluation value of the sample.

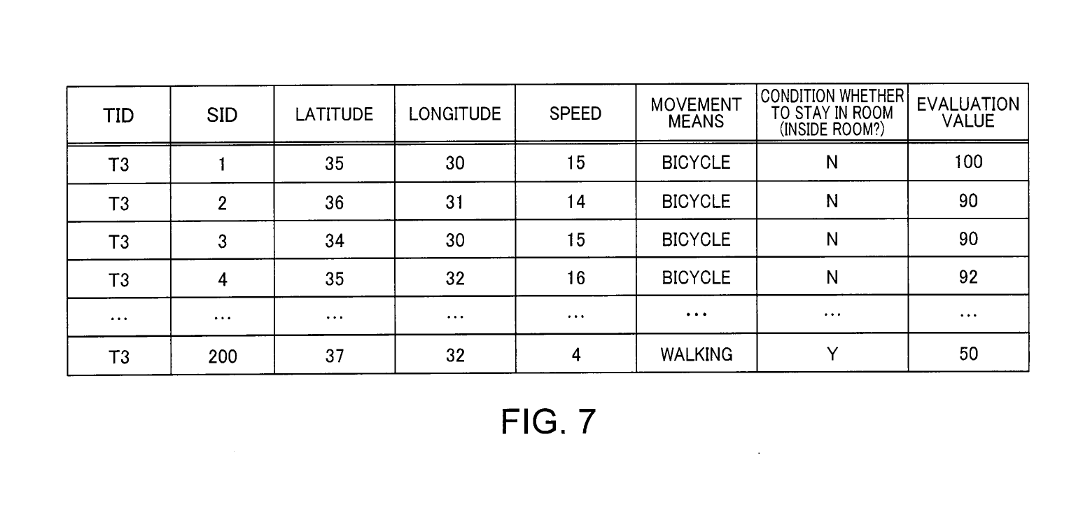

The evaluation value of each of the samples (t) calculated by the evaluator 105 is kept in the sample storage 102 and stored so as to be associated with each of the samples (t). FIG. 7 is a diagram illustrating exemplary evaluation values stored in the sample storage 102. In the example in FIG. 7, the evaluation value of each of the samples in FIG. 4 is calculated. In FIG. 7, for example, the evaluation value of a sample 1 is 100.

Based on the sample (t) and the evaluation value thereof stored in the sample storage 102, the position state estimator 106 (hereinafter, referred to as “estimator 106”) estimates the position state of the user at the time (t). The estimator 106 may estimate a sample with the highest evaluation value as the position state at the time (t), or alternatively, may select samples with the evaluation values equal to or higher than a predetermined value and estimate an average value or a mode value of the selected samples as the position state at the time (t).

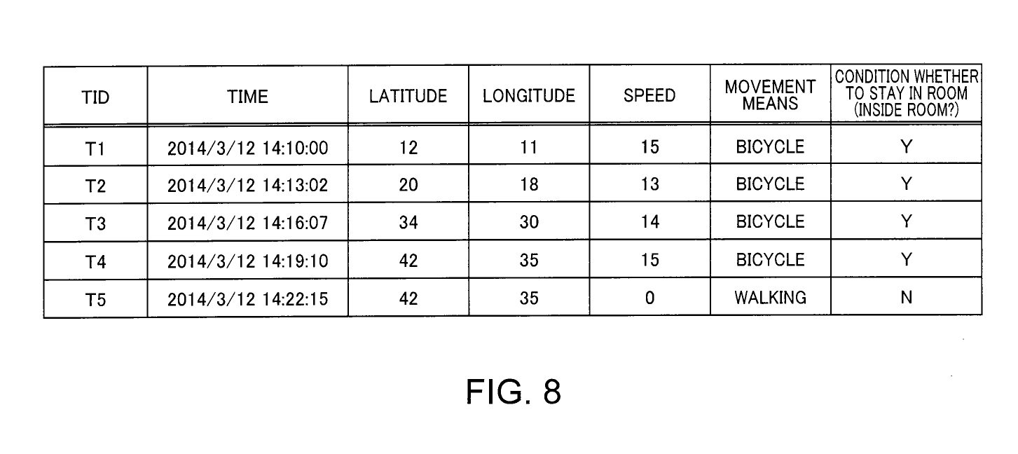

The estimation result storage 107 stores the position state at each time of day estimated by the estimator 106. FIG. 8 is a diagram illustrating exemplary estimation results for the position states stored in the estimation result storage 107. According to FIG. 8, for example, in the position state at the time T1, the latitude is 12 degrees; the longitude is 11 degrees; the speed is 15 km/h; the movement means is a bicycle; and the condition whether to stay in the room is inside the room (inside the room=Y). The position state at each time of day stored in the estimation result storage 107 can be used in the position state application.

Based on the estimation result for the position state stored in the estimation result storage 107 and the path information stored in the transition model storage 103, the destination selector 108 (hereinafter, referred to as “selector 108”) selects a destination of the user. The path information includes a plurality of destination candidates and movement paths between the respective destination candidates. The destination candidate may be input by the user. Alternatively, a location with a possibility of staying for a long time may be automatically extracted as the destination candidate based on a movement history of the user in the past, or the destination candidate may be obtained from an external database such as the position state information provision server 3. In addition, the movement paths between the destination candidates may be obtained from a vector road map or the like.

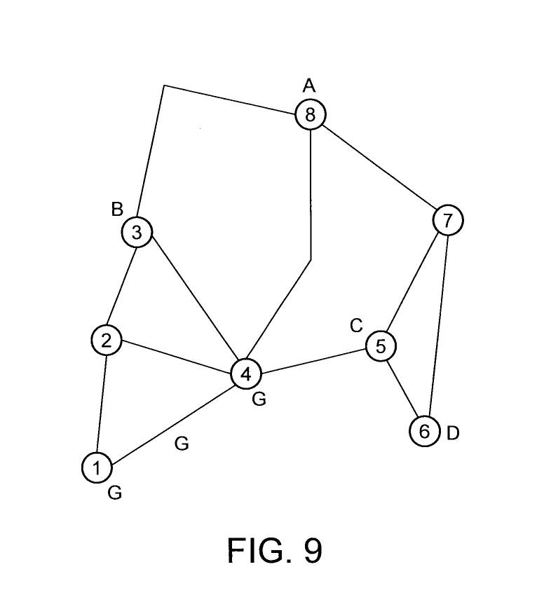

FIG. 9 is a schematic diagram illustrating exemplary path information. In FIG. 9, nodes 1 to 8 indicate respective candidate destinations, paths connecting the nodes with each other indicate the respective movement paths, and signs G indicate estimated positions of the user at each time of day. In the example in FIG. 9, the user moves from the node 1 toward the node 4, and the nodes 8, 3, 5, and 6 are selected as the destinations A, B, C, and D, respectively.

First, the selector 108 calculates the movement path of the user from a starting position to the current position based on the estimation result for the position state. The positions of the user at any time of day before the time (t), stored in the estimation result storage 107, can be used as the starting position. The current position is a position of the user at the time (t) stored in the estimation result storage 107.

Next, the selector 108 compares the path of the user with the candidate destinations to select a destination based on the comparison result. For example, in a case where the shortest path from the starting position to a candidate destination matches the movement path of the user, the selector 108 selects that candidate destination as the destination. The shortest path mentioned here is a path with the shortest required time or the shortest distance from the starting position to the candidate destination.

Additionally, the selector 108 may select, as the destination, a candidate destination other than an unreasonable candidate destination. Examples of the unreasonable candidate destination include a candidate destination through which the user has already passed (node 1 in FIG. 9), and a candidate destination in a case where the shortest path from the starting position to the candidate destination does not match the movement path of the user (node 2 in FIG. 9).

Furthermore, the selector 108 may calculate unreasonableness of the candidate destinations to select, as the destination, a candidate destination with the unreasonableness equal to or lower than a predetermined value. For example, the unreasonableness of the candidate destination may be a ratio of a distance of the shortest path from the starting position to the candidate destination, to a sum of a distance of the movement path of the user and a distance of the shortest path from the current position to the candidate destination.

In FIG. 9, when it is assumed that a distance between the nodes 1 and 2 is 10, a distance between the nodes 1 and 4 is 12, a distance between the nodes 2 and 4 is 10, a distance between the nodes 2 and 3 is 8, and a distance between the nodes 3 and 4 is 11, the unreasonableness of the node 2 in FIG. 9 is expressed as (distance between the nodes 1 and 4+distance between the nodes 2 and 4)/(distance between the nodes 1 and 2)=(12+10)/10=2.2. On the other hand, the unreasonableness of the node 3 is expressed as (distance between the nodes 1 and 4+distance between the nodes 3 and 4)/(distance between the nodes 1 and 2+distance between the nodes 2 and 3)=(12+11)/(10+8)≈1.3. When a threshold of the unreasonableness is set to 1.5, the node 2 is not selected as the destination, whereas the node 3 is selected as the destination.

Note that a method of selecting the destination is not limited to the above. A combination of the aforementioned methods may be used as the method of selecting the destination, or alternatively, another method such as a rule-based method may be employed.

Based on the path information, the valid path searcher 109 (hereinafter, referred to as “searcher 109”) searches for a valid path from the current position of the user to the destination selected by the selector 108. The valid path is the shortest path from the current position to the destination, or a sufficiently acceptable path when compared with the shortest path. The acceptable path is a path with required time or a distance within a predetermined range relative to the required time or the distance for the shortest path. The valid path may be a path with the shortest required time, a path with a distance comparable to the shortest distance, or an acceptable path when compared with these paths.

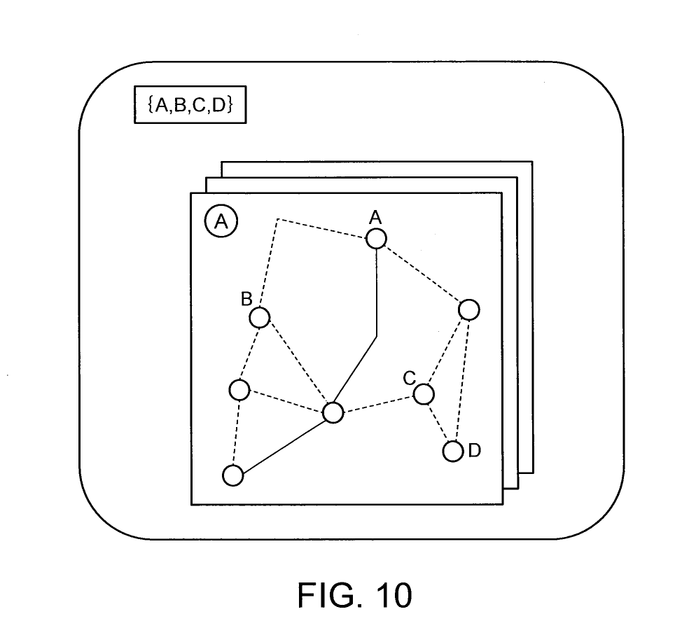

FIG. 10 is a schematic diagram illustrating an exemplary valid path. In the example in FIG. 10, a valid path to a destination A is illustrated. The searcher 109 searches for such valid path as illustrated in FIG. 10 for each of the destinations.

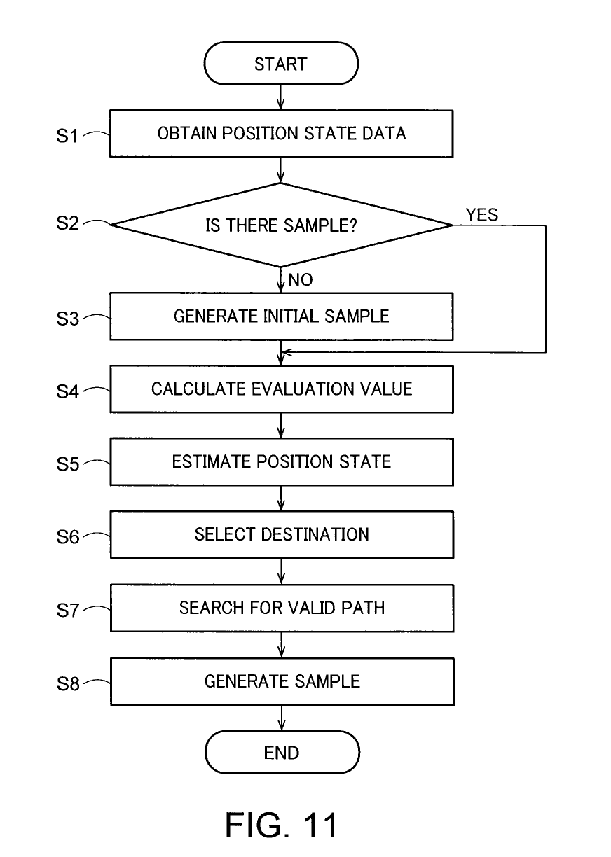

Next, operation of the estimation device according to the embodiment will be specifically described with reference to FIGS. 11 to 14. FIG. 11 is a flowchart illustrating the operation of the estimation device. The estimation device carries out the operation illustrated in FIG. 11 at the respective operation timings. Hereinafter, the current time is referred to as time (t) and the subsequent operation timing is referred to as time (t+1).

In step S1, the evaluator 105 obtains the position state data at the time (t) from the position state data storage 12.

In step S2, the evaluator 105 confirms whether a sample at the time (t) is stored in the sample storage 102. When the sample at the time (t) is stored (YES in step S2), the processing proceeds to step S4. Meanwhile, when the sample at the time (t) is not stored (NO in step S2), the processing proceeds to step S3.

In step S3, the initializer 104 obtains the position state data at the time (t) from the position state data storage 12 and generates N initial samples based on the state transition model and the path information.

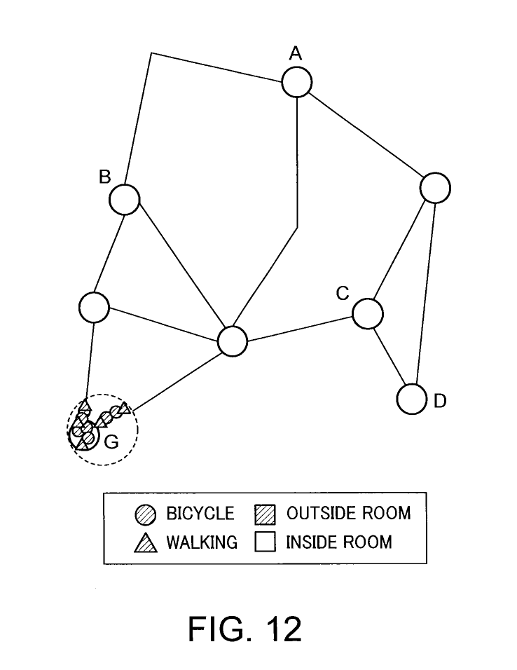

FIG. 12 is a diagram illustrating exemplary initial samples. In the example in FIG. 12, the position state data at the time T1 in FIG. 2 is assumed to be obtained as the position state data at the time (t). In FIG. 12, G indicates a measurement position (the latitude and the longitude) at the time T1, whereas a dotted line indicates a range of position measurement accuracy (a range in which the user is possibly present in accordance with the position measurement accuracy). In addition, a circular mark indicates a sample whose movement means is a bicycle, a triangular mark indicates a sample whose movement means is walking, a shaded mark indicates a sample whose condition whether to stay in the room is outside the room, and a solid-color mark is a sample whose condition whether to stay in the room is inside the room. For example, a shaded circular mark indicates a sample whose position state represents outside the room and a bicycle.

In FIG. 12, the initializer 104 generates the respective samples so that the samples are positioned on paths within the range of the position measurement accuracy. Positions of the respective samples may be determined using random numbers, or alternatively, may be determined using normal distribution in which the measurement position is assumed as the center.

Additionally, the movement means of each sample may be determined using uniform distribution, or alternatively, may be determined based on a rule. For example, such rule as that a train is not used in a case where no station or no railway exists in a vicinity of the measurement position may be employed. In the example in FIG. 12, samples whose movement means are a bicycle and samples whose movement means are walking are generated with the equal probability.

Additionally, the conditions, of the respective samples, whether to stay in the room may be determined using the uniform distribution or determined depending on the movement means of the respective samples (for example, in a case where the movement means is a bicycle, the condition whether to stay in the room is determined as outside the room). Alternatively, the conditions whether to stay in the room may be determined based on a rule. For example, it is considered to employ a rule that the user does not move to inside the room at a place other than the destination candidates. In the example in FIG. 12, the conditions, of all the samples, whether to stay in the room are outside the room.

Additionally, the speeds of the respective samples can be determined based on the positions, the movement means, and the conditions whether to stay in the room of the respective samples. For example, the speed may be determined with reference to the speed in accordance with the movement means included in the transition model, or the speed of the sample inside the room may be set to zero. The speed may also be calculated based on the position state data at the time (t) and at time prior to the time (t).

According to the methods described thus far, the initializer 104 can generate N initial samples including, as the position state, the position, the speed, the movement means, and the condition whether to stay in the room.

In addition, the position state of each of the samples may include the movement direction, the acceleration pattern, and the like. In this case, the movement direction, the acceleration pattern, and the like may be determined at random based on the position state data. In a case where a positive direction of a path is set in advance, the movement direction may be expressed as a sign of the speed.

In step S4, the evaluator 105 obtains N samples (t) (or initial samples (t)) from the sample storage 102 to calculate the evaluation values of the respective samples based on the position state data at the time (t). The calculation method for the evaluation value is as described above. The evaluation value is stored in the sample storage 102 together with each of the samples (t) (see FIG. 7).

In step S5, the estimator 106 obtains N samples (t) from the sample storage 102 to estimate the position state of the user at the time (t). The estimation method for the position state is as described above. The estimation result is stored in the estimation result storage 107 (see FIG. 8).

In step S6, the selector 108 obtains the estimation result from the estimation result storage 107 to select a destination based on the estimation result and the path information. The method of selecting the destination is as described above. In a case where the initial sample (t) is generated at the time (t), the selector 108 may select all destination candidates as the destination.

In step S7, the searcher 109 searches for a valid path from the estimated position at the time (t) to each of the destinations (see FIG. 10). The searching method for the valid path is as described above.

In step S8, the sampler 101 obtains the transition model, N samples (t), and the valid paths to the respective destinations to generate N samples (t+1) on the valid paths.

First, the sampler 101 selects, from among N samples (t), a sample (t) for which the transition is to be carried out. The sampler 101 may select a sample (t) with the highest evaluation value or select a plurality of samples (t) with the evaluation values equal to or higher than a predetermined value.

Next, the sampler 101 carries out the transition of the selected sample (t) along the valid path based on the transition model. For example, the transition of the speed and the position of the sample (t) is carried out using the following expression.

[Math. 2]

vₜ₊₁=vₜ×norm(1.0,σ)

xₜ₊₁=move(xₜ,vₜ₊₁*T) (2)

In expression (2), vₜ indicates a speed of the sample (t); vₜ₊₁ indicates a speed of the sample (t) after the transition; norm(1.0, σ) indicates a normal distribution function in which a noise a is set as a parameter; xₜ indicates a position of the sample (t); xₜ₊₁ indicates a position of the sample (t) after the transition; T indicates a time interval from the time (t) to the time (t+1); and move(xₜ, vₜ₊₁*T) indicates a movement function for moving the sample along the valid path. By using move(xₜ, vₜ₊₁*T), a position away from the position xₜ by a distance D (=vₜ₊₁×T) is calculated on the valid path.

In a case where a branching point is present within the distance D of the position xₜ, the transition of the position xₜ is simply carried out in accordance with the selection probability of the path as illustrated in FIG. 5. With regard to the movement means and the condition whether to stay in the room of the sample (t), the transition thereof is also simply carried out in accordance with the transition probability of the movement means and the probability for moving into/out of the room as illustrated in FIG. 5. In addition, the transition of the speed of the sample (t) may be carried out so as to be the speed in accordance with the movement means as illustrated in FIG. 5, or alternatively, may be carried out by adding disturbance due to the standard deviation.

The position state of the sample (t) after the transition serves as the sample (t+1) at the time (t+1). By using such method as described above, the sampler 101 generates N samples (t+1) on the valid paths. The generated samples (t+1) are stored in the sample storage 102.

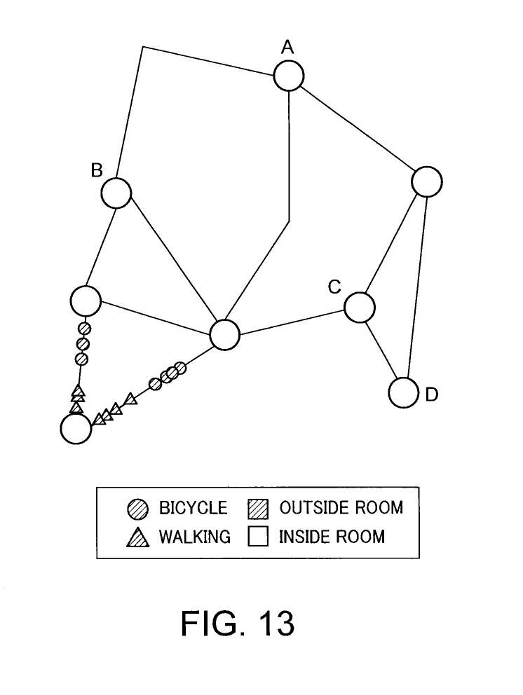

A conventional estimation device, which does not select a destination or search for a valid path, generates N samples (t+1) on all possible paths for the transition as illustrated in FIG. 13. In other words, some of N samples (t+1) are generated on paths other than the valid paths.

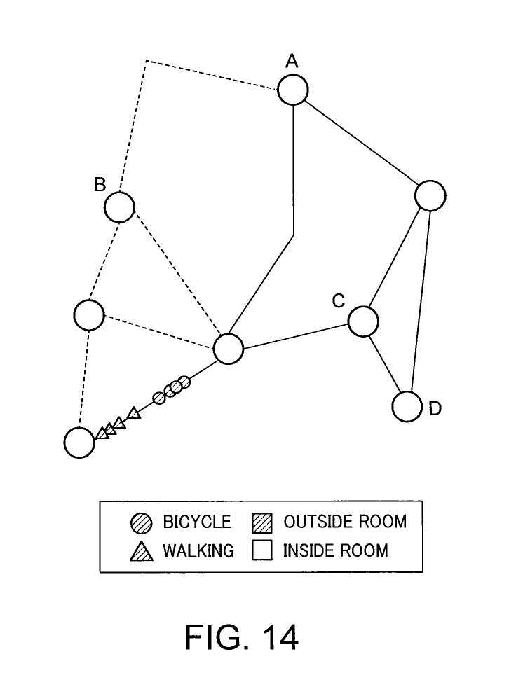

Compared to this, the estimation device according to the embodiment generates all N samples (t+1) on the valid paths as illustrated in FIG. 14. In the example in FIG. 14, the destinations A, C, and D are selected. In addition, solid lines indicate the valid paths and dashed lines indicate paths other than the valid paths.

As described thus far, in the estimation device according to the embodiment, paths with a lower possibility of the user moving thereto are pruned to generate the samples located on the valid paths with a higher possibility of the user moving thereto. Therefore, generation of the samples with lower estimation accuracy is suppressed so that the position state can be accurately estimated with a smaller number of the samples.

By using the estimation device according to the embodiment, based on the position state data, with a lower frequency in sampling, obtained from a portable terminal or the like, the position state of the user can be estimated in a shorter period of time. The estimation result for the position state can be used to realize provision of real-time information in such cases as “showing information upon getting off the car”.

The estimation result can also be used to assist decision making. For example, in equipment maintenance services or transport services, the position states of a plurality of field staff can be estimated in real time and managed at an operation center or the like, so that an optimum field staff is selected with ease to be dispatched in response to a request from a customer. The field staff may be selected by an operator or may be automatically selected based on any type of a logic.

Furthermore, when passage data inside a building or a floor plan is used as the path information, the estimation device can estimate the position state of the staff inside a building such as a hospital or a commercial facility. Also in this case, in the same manner as the above, the estimation result can be used to provide real-time information or to assist decision making.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A position state estimation device to estimate a position state including a position of a moving object, comprising:
an evaluator to calculate, based on a measurement value of the position state at time (t), an evaluation value of a sample (t) of the position state at the time (t);
an estimator to estimate, based on the sample (t) and the evaluation value, the position state at the time (t);
a selector to select, based on the estimated position state at the time (t), a destination of the moving object from among destination candidates;
a searcher to search for a valid path to the destination; and
a sampler to generate, based on a transition model of the position state, the sample (t), and the valid path, a plurality of samples (t+1) for a subsequent operation timing after the time (t).

2. The device according to claim 1, wherein
the sampler carries out transition of the sample (t) along the valid path based on the transition model to generate the sample (t+1).

3. The device according to claim 1, wherein
the valid path includes a path at least either with a shortest required time or with a shortest distance to the destination.

4. The device according to claim 1, wherein
in a case where a movement path of the moving object from a starting position to a position at the time (t) matches a shortest path from the starting position to the destination candidate, the selector selects, from among the destination candidates, that destination candidate as the destination.

5. The device according to claim 1, wherein
the evaluation value is calculated based on likelihood of the sample (t) with respect to the measurement value at the time (t).

6. The device according to claim 1, wherein
the evaluation value becomes smaller as a difference between a position of the moving object contained in the sample (t) and a position of the moving object contained in the measurement value is enlarged.

7. The device according to claim 1, wherein
the evaluation value becomes smaller as a difference between a movement direction of the moving object based on the sample (t) and a movement direction of the moving object based on the measurement value is enlarged.

8. The device according to claim 1, wherein
the position state includes at least one of a speed, a movement direction, and a movement means of the moving object.

9. A position state estimation method that estimates a position state including a position of a moving object, comprising:
calculating, based on a measurement value of the position state at time (t), an evaluation value of a sample (t) of the position state at the time (t);
estimating, based on the sample (t) and the evaluation value, the position state at the time (t);
selecting, based on the estimated position state at the time (t), a destination of the moving object from among destination candidates;
searching for a valid path to the destination; and
generating, based on a transition model of the position state, the sample (t), and the valid path, a sample (t+1) for a subsequent operation timing after the time (t).
